(19) United States
(12) Patent Application Publication
(10) Pub. No.: US 2004/0182281 A1
(43) Pub. Date: Sep. 23, 2004

(54) Dry erase ink

(76) Inventor: Vincent Kwan, Chicago, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/776,965

(22) Filed: Feb. 11, 2004

Related U.S. Application Data
(60) Provisional application No. 60/447,147, filed on Feb. 13, 2003.

(51) Int. Cl. C09D 11/00

(52) U.S. Cl. 106/31.65; 106/31.9; 106/31.86; 106/31.89

(57) ABSTRACT

An aqueous dry erase ink, including a pigment, a release agent, and a binder, and optionally including one or more of a dye, a co-solvent, a surfactant, a biocide, a surface tension modifier, a surfactant, and a humectant, is disclosed. Also disclosed are methods of making and using the ink and a marker containing the ink.

### CROSS-REFERENCE TO RELATED APPLICATION

The benefit under 35 U.S.C. §119(e) of U.S. Provisional Patent Application Serial No. 60/447,147 filed Feb. 13, 2003, is hereby claimed.

### BACKGROUND

1. Field of the Disclosure

The disclosure relates generally to marking inks. More particularly, the disclosure relates to dry erase marking inks.

2. Brief Description of Related Technology

A typical dry erase board (“white board”) includes a white board or substrate that is coated with a relatively non-porous surface such as an enamel, film, ultraviolet cured liquid, liquid varnish, or porcelain finish. Specially designed markers are employed to write on the boards. While the ink of the marker dries on the substrate, the ink does not bond to the substrate surface and the writing can be easily removed with a soft eraser, cloth, finger, and the like. Dry erase board and markers have gained in popularity due to their convenience, functionality, and cleanliness (e.g., the substantial freedom from dust, contrasted with chalk boards). However, with the intent of having a fast drying rate on the board, previous dry erase ink solvents have been based on volatile organic solvents such as methyl ethyl ketone. Some organic solvents may not be acceptable to all consumers, despite their fast drying rate, due to aesthetic considerations and irritation.

In addition, with the intent of preventing staining of a dry erase board, prior dry erase inks have used pigment particles in place of a dye. Such pigment-based dry erase inks, however, are not easily laundered from fabrics. To improve washability, dye-based dry erase inks have been formulated, but such inks can tend to stain white boards, especially more porous white boards such as low quality boards, and boards which have become more porous through use.

### SUMMARY

The disclosure provides a dry erase ink comprising a large particle size pigment, a release agent, and a binder, in an aqueous solvent.

Further aspects and advantages may become apparent to those skilled in the art from a review of the following detailed description, taken in conjunction with the drawings. While the disclosed inks are susceptible of embodiments in various forms, described hereinafter are specific embodiments with the understanding that the disclosure is illustrative, and is not intended to limit the invention to the specific embodiments described herein.

### DETAILED DESCRIPTION

The disclosure relates generally to a dry erase ink, such as the type that can be used on relatively non-porous dry erase board and erased without the use of a solvent. The ink includes a large particle size pigment, a release agent, and a binder, in an aqueous solvent. The ink optionally, but preferably, includes one or more of a dye, a co-solvent, and a surfactant.

As described below, the dry erase ink can be formulated to have one or more advantageous characteristics as a result of selection of the ink components and the relative proportions thereof. Accordingly, one embodiment of the ink disclosed herein is a dry erase ink that has improved washability from textiles. Another embodiment of the ink disclosed herein is a dry erase ink that has improved erasability. Still another embodiment of the ink disclosed herein is a dry erase ink that is both easily erased from a typical dry erase board and easily removed from textiles by laundering.

The dry erase ink includes a large particle size pigment. Without intending to be bound by any particular theory, it is believed that the large particle size of the pigment tends to block dyes, when used, from staining a white board. Without intending to be bound by any particular theory, it is also believed that as the particle size increases, the ability of the particles to be removed from textiles by laundering (i.e., washability) also increases. Thus, the large particle size of the pigment in some embodiments of an ink as disclosed herein can provide improved washability as compared to prior dry erase inks. In addition, however, as the particle size increases the probability that particles will be trapped by marker reservoir and nib materials may also increase, thus increasing the probability that a marker made with such materials will clog and lose functionality. For example, typical marker reservoir and nib materials have an upper limit of about 75% porosity. Reported porosity values, however, can have different meanings depending on the material manufacturer, such that the reported value is typically only an approximation. In addition, the pore size (e.g., minimum pore size) of a nib material can be a more determining factor on how an ink having a given particle size will perform, but such pore size information is rarely available.

Pigments do not have uniform particle sizes, but instead typically have a range of sizes distributed about a nominal particle size, often the average (mean), or highest frequency (mode). Particle size specifications by pigment suppliers can represent the mean, median, or mode of particle size, but in most cases a pigment of specified particle size will have at least a majority of the particles within one standard deviation of the nominal particle size. Accordingly, particle size as specified herein represents a pigment wherein at least a majority of the particles are within one standard deviation of the nominal particle size. In view of the foregoing, the particle size of the pigment for use in the dry erase ink described herein preferably is at least, about 1 μm or greater than 1 μm, whereas pigments used in typical dry erase inks are frequently less than 0.1 μm in diameter. In additional embodiments, the particle size of the pigment is at least about 2 μm or greater than 2 μm, at least about 3 μm or greater than 3 μm, at least about 4 μm or greater than 4 μm, or at least about 5 μm or greater than 5 μm. The particle size of the pigment for most practical purposes preferably is about 40 μm or less for use with presently-available nib and reservoir materials, but can be larger (e.g., hundreds of microns) in theory.

Preferred pigments for use in the dry erase ink include metallic pigments such as aluminum pigments. Suitable aluminum flake pigments are available from Edgmont Pigment Company of West Chester, Pa., such as an 18 μm average diameter aluminum flake pigment sold under the designation 7160 nl NW as a paste of 60% aluminum by weight (wt. %) in mineral oil. Other suitable pigments include, but are not limited to, organic-pigments, inorganic pigments (e.g., iron oxides), and interference pigments. Interference pigments will generally have a particle size of at least about 5 μm to achieve the intended visual effect. A dual-color pigment such as one in the DUOCHROM series available from Engelhard Corporation of Iselin, N.J., can also be used. With such a pigment, the ink will exhibit different colors when written on a white board and a black “white”(i.e., low-porosity) board. Organic pigments and metallic (e.g., aluminum) pigments are most preferred.

When a white pigment (examples include titanium dioxide, zinc oxide, calcium oxide, and barium-sulphate) is used in conjunction with the dry erase formulation, a “dustless” white chalk marker will be created. Such an embodiment may be useful for teachers to use with a black dry erase board to give the effect of chalk on a black slate chalkboard (i.e., a blackboard).

A large particle size pigment preferably will be used in the dry erase ink in an amount in a range of about 0 wt. % to about 80 wt. %, preferably 0. 1 wt. % to about 50 wt. %, and typically about 1 wt. % to about 10 wt. %.

The dry erase ink also includes a release agent to keep the pigment particles from sticking to a white board or other substrate, and convert the ink into powder form when dry. Suitable release agents include, but are not limited to, silicones (e.g., silicone fluids, silicone silanes, and organofunctional silanes). A suitable release agent that also has surface-tension reducing functionality is a polyalkylene oxide-modified polydimethylsiloxane sold as SILWET L-7607 by OSi Specialties, Inc. of South Charleston, W.Va. A release agent preferably is present in the dry erase ink in an amount in a range of about 0.5 wt. % to about 30 wt. %, preferably between 1 wt. % and 15 wt. %.

A binder resin aids in adhering the solid and dried components of the ink to a substrate such as a white board and in binding the solid and dried components of the ink together. The binder resin is soluble in the ink solvent, and preferably is water-soluble. A suitable binder resin is one which, together with the other ink components, can be readily removed from the intended substrate, preferably a low-porosity substrate such as a white board. The resin can be cationic, anionic, or non-ionic. The resin is included in the ink-in an amount at least 0.5 wt. %. Preferably, the resin is included in an amount about 90 wt. % or less, more preferably about 50 wt. % or less. The amount of binder resin should be such that the ink has a viscosity suitable for delivery by a capillary nib (and reservoir, if used). A suitable amphoteric binder resin (non-ionic at pH 5 to 6) is sold as an approximately 25 wt. % solid under the name RITE BRITE Br Base by Chemurgy, Inc., of Greenville, S.C.

Water is the primary solvent used in the dry erase ink, in a range of about 10 wt. % to about 99 wt. %, preferably about 20 wt. % to about 99 wt. %. A co-solvent can be used in the ink to regulate the evaporation rate of the ink solvent. For example, the drying rate of the ink on a substrate preferably will be less than about ten seconds, and the cap-off time of a marker made with the ink preferably will be about four to about six hours. Preferably, the evaporation rate of the ink solvent is less than one (butyl acetate=1). The co-solvent can optionally enhance the solvancy of the mixture for one or more dyes, when used. The co-solvent can be any solvent that is miscible with water. Alcohols, such as isopropanol, are preferred. A co-solvent is preferably included in an amount in a range of about 10 wt. % to about 99 wt. % of the ink.

As described above, the dry erase ink can also include a dye. One or more dyes can be used as the primary coloring agents, such as with an aluminum-pigmented ink, or dyes can be used to tint an ink containing a colored pigment. Acid dyes, basic dyes, and polymeric dyes (e.g., made by attaching dye chromophores onto a common polymeric backbone) are preferred. Examples of such dyes include, but are not limited to, Palmer Blue, Palmer Scarlet, Palmer Red, and the like, available from Milliken Chemical Company of Spartanburg, S.C. Such polymeric dyes are described in one or more of U.S. Pat. Nos. 4,981,516 (Jan. 1, 1991), 5,043,013 (Aug. 27, 1991), and 5,059,244 (Oct. 22, 1991). In an embodiment wherein the dry erase ink is desired to be washable, the use of solvent-soluble dyes, reactive dyes, vat dyes, direct dyes, and disperse dyes in substantial amounts should be avoided.

A dye, when used, preferably will be included in the ink in an amount at least about 0.005 wt. % to provide perceivable color, and more preferably at least about 0.5 wt. %. More than one dye can be mixed to achieve a wide variety of colors, however the relative concentrations of the dyes should be adjusted such that there is not a substantial effect on the stability of the ink, for example by interaction of dyes such as acid dyes and basic dyes.

For delivery by a typical capillary marker, the ink viscosity preferably will be less than 20 cP, preferably from about 1 cP to about 10 cP, and more preferably from about 1 cP to about 5 cP (all values at 25 ° C.). The ink viscosity, however, can be substantially higher if non-traditional marker components, such as higher porosity components, are used.

The ink can also include other optional additives, such as biocides, surface tension modifiers (including wetting agents), surfactants, humectants, or any other additive useful in an ink which does not distract from the dry erase purpose of the ink disclosed herein.

Surfactants can include glycol ethers and phosphate esters.

An ink as described herein can be made by mixing the selected components in the amounts desired until homogenous. Preferably, components are added to each other in the categorical series of solvents, optional additives, co-solvents, pigments, and then dyes. Preferably, an ink is mixed prior to loading into a reservoir, to assure uniformity in case of settling prior to loading.

The ink can be used by dispensing it onto a substrate, preferably a low-porosity substrate. The ink can be further used by wiping the ink off a substrate, preferably without the use of a solvent, such as with a felt eraser.

Any open reservoir that is able to stabilize the ink and allows the ink to pass through without restriction can be used. Suitable materials include polyvinyl alcohol, polypropylene, polyethylene, and the like. Examples of such a reservoir include melt-blown reservoirs from Filtrona Richmond, Inc. of Colonial Heights, Va. The dimensions of the reservoir can vary according to those of the marker barrel.

A marker nib should also have an open structure to allow continual delivery of relatively large particle pigments. The nib should also be chemically neutral towards the ink components. An example of such a nib is a polyester nib supplied by Teibow Hanbai Co., Ltd. of Tokyo, Japan, under the designation TC243P.

### EXAMPLES

The following examples are provided to illustrate the invention but are not intended to limit the scope of the invention.

### Example 1

### Yellow Dry Erase Ink

The components identified in Table 1 below were carefully weighed, added to a container of the appropriate size in the order listed, and mixed until homogenous.

TABLE 1

| | | | | Amount |
|---|---|---|---|---|
| Trade Name | Component | Function | Supplier | (wt. %) |
| | water | solvent | | 31.94 |
| | isopropyl alcohol (IPA) | co-solvent | | 17.1 |
| DEP (10 wt. % in | glycol ether | surfactant | Chemurgy | 1.14 |
| IPA) | | | | |
| CHEMPHOS | phosphate ester | surfactant | Chemurgy | 1.14 |
| TC310 | | | | |
| SILWET L-7607 | polyalkylene oxide- | release agent | OSi | 5.84 |
| | modified | | Specialties | |
| | polydimethylsiloxane | | | |
| SURFYNOL 440 | ethoxylated 2,4,7,9- | wetting agent | Air Products | 3.42 |
| | tetramethyl 5 decyn-4,7- | | | |
| | diol | | | |
| | glycerine | | | 1.14 |
| Rite Brite Br | | water-based resin | Chemurgy | 28.52 |
| Base | | | | |
| 7160 nl NW | aluminum paste | pigment | Edgmont | 3.76 |
| | | | Pigment | |
| Palmer Yellow | polymeric dye | color agent | Milliken | 5.97 |
| | | | Chemical | |

### Example 2

### Blue Dry Erase Ink

The components identified in Table 2 below were carefully weighed, added to a container of the appropriate size in the order listed, and mixed until homogenous.

TABLE 2

| | | | | Amount |
|---|---|---|---|---|
| Trade Name | Component | Function | Supplier | (wt. %) |
| | water | solvent | | 31.66 |
| | isopropyl alcohol (IPA) | co-solvent | | 16.96 |
| DEP (10 wt. % in | | surfactant | Chemurgy | 1.13 |
| IPA) | | | | |
| CHEMPHOS | phosphate ester | surfactant | Chemurgy | 0.131 |
| TC310 | | | | |
| SILWET L-7607 | polyalkylene oxide- | release agent | OSi | 5.79 |
| | modified | | Specialties | |
| | polydimethylsiloxane | | | |
| SURFYNOL 440 | ethoxylated 2,4,7,9- | wetting agent | Air Products | 3.39 |
| | tetramethyl 5 decyn-4,7- | | | |
| | diol | | | |
| | glycerine | | | 1.13 |
| Rite Brite Br Base | | water-based resin | Chemurgy | 28.57 |
| 7160 nl NW | aluminum paste | pigment | Edgmont | 3.73 |
| | | | Pigment | |
| Palmer Blue | polymeric dye | color agent | Milliken | 6.8 |
| | | | Chemical | |

### Example 3

### Magenta Dry Erase Ink

The components identified in Table 3 below were carefully weighed, added to a container of the appropriate size in the order listed, and mixed until homogenous.

TABLE 3

| | | | | Amount |
|---|---|---|---|---|
| Trade Name | Component | Function | Supplier | (wt. %) |
| | water | solvent | | 32.78 |
| | isopropyl alcohol (IPA) | co-solvent | | 17.56 |
| DEP (10 wt. % in | | surfactant | Chemurgy | 1.17 |
| IPA) | | | | |
| CHEMPHOS | phosphate ester | surfactant | Chemurgy | 1.17 |
| TC310 | | | | |
| SILWET L-7607 | polyalkylene oxide- | release agent | OSi | 5.99 |
| | modified | | Specialties | |
| | polydimethylsiloxane | | | |
| SURFYNOL 440 | ethoxylated 2,4,7,9- | wetting agent | Air Products | 3.51 |
| | tetramethyl 5 decyn-4,7- | | | |
| | diol | | | |
| | glycerine | | | 1.17 |
| Rite Brite Br Base | | water-based resin | Chemurgy | 29.27 |
| 7160 nl NW | aluminum paste | pigment | Edgmont | 3.86 |
| | | | Pigment | |
| Palmer Magenta | polymeric dye | color agent | Milliken | 3.52 |
| | | | Chemical | |

### Example 4

### Green Dry Erase Ink

The components identified in Table 4 below were carefully weighed, added to a container of the appropriate size in the order listed, and mixed until homogenous.

TABLE 4

| | | | | Amount |
|---|---|---|---|---|
| Trade Name | Component | Function | Supplier | (wt. %) |
| | water | solvent | | 31.35 |
| | isopropyl alcohol (IPA) | co-solvent | | 16.8 |
| DEP (10 wt. % in | | surfactant | Chemurgy | 1.12 |
| IPA) | | | | |
| CHEMPHOS | phosphate ester | surfactant | Chemurgy | 1.12 |
| TC310 | | | | |
| SILWET L-7607 | polyalkylene oxide- | release agent | OSi | 5.73 |
| | modified | | Specialties | |
| | polydimethylsiloxane | | | |
| SURFYNOL 440 | ethoxylated 2,4,7,9- | wetting agent | Air Products | 3.36 |
| | tetramethyl 5 decyn-4,7- | | | |
| | diol | | | |
| | glycerine | | | 1.12 |
| Rite Brite Br Base | | water-based resin | Chemurgy | 27.99 |
| 7160 nl NW | aluminum paste | pigment | Edgmont | 3.69 |
| | | | Pigment | |
| Palmer Yellow | polymeric dye | color agent | Milliken | 2.97 |
| | | | Chemical | |
| Palmer Blue | polymeric dye | color agent | Milliken | 0.55 |
| | | | Chemical | |

### Example 5

### Purple Dry Erase Ink

The components identified in Table 5 below were carefully weighed, added to a container of the appropriate size in the order listed, and mixed until homogenous.

TABLE 5

| | | | | Amount |
|---|---|---|---|---|
| Trade Name | Component | Function | Supplier | (wt. %) |
| | water | solvent | | 30.56 |
| | isopropyl alcohol (IPA) | co-solvent | | 16.37 |
| DEP(10 wt. % in | | surfactant | Chemurgy | 1.09 |
| IPA) | | | | |
| CHEMPHOS | phosphate ester | surfactant | Chemurgy | 1.09 |
| TC310 | | | | |
| SILWET L-7607 | polyalkylene oxide- | release agent | OSi | 5.59 |
| | modified | | Specialties | |
| | polydimethylsiloxane | | | |
| SURFYNOL 440 | ethoxylated 2,4,7,9- | wetting agent | Air Products | 3.27 |
| | tetramethyl 5 decyn-4,7- | | | |
| | diol | | | |
| | glycerine | | | 1.09 |
| Rite Brite Br Base | | water-based resin | Chemurgy | 27.29 |
| 7160 nl NW | aluminum paste | pigment | Edgmont | 3.6 |
| | | | Pigment | |
| Palmer Scarlet | polymeric dye | color agent | Milliken | 7.28 |
| | | | Chemical | |
| Palmer Blue | polymeric dye | color agent | Milliken | 2.76 |
| | | | Chemical | |

### Example 6

### Red Dry Erase Ink

The components identified in Table 6 below were carefully weighed, added to a container of the appropriate size in the order listed, and mixed until homogenous.

TABLE 6

| | | | | Amount |
|---|---|---|---|---|
| Trade Name | Component | Function | Supplier | (wt. %) |
| | water | solvent | | 30.56 |
| | isopropyl alcohol (IPA) | co-solvent | | 16.39 |
| DEP(10 wt. % in | | surfactant | Chemurgy | 1.09 |
| IPA) | | | | |
| CHEMPHOS | phosphate ester | surfactant | Chemurgy | 1.09 |
| TC310 | | | | |
| SILWET L-7607 | polyalkylene oxide- | release agent | OSi | 5.59 |
| | modified | | Specialties | |
| | polydimethylsiloxane | | | |
| SURFYNOL 440 | ethoxylated 2,4,7,9- | wetting agent | Air Products | 3.28 |
| | tetramethyl 5 decyn-4,7- | | | |
| | diol | | | |
| | glycerine | | | 1.09 |
| Rite Brite Br Base | | water-based resin | Chemurgy | 27.31 |
| 7160 nl NW | aluminum paste | pigment | Edgmont | 3.6 |
| | | | Pigment | |
| Palmer Scarlet | polymeric dye | color agent | Milliken | 9.97 |
| | | | Chemical | |

Two key preferred attributes of dry erase markers are erasability from white boards and washability from clothes and other fabrics. To this end, Examples 7 and 8 below show the results of testing and comparison for both of these aspects of dry erase markers,

### Example 7

### Erasability

To assess erasability from white boards, marks were made on a board by the inks according to Examples 1-6 and left overnight to, dry. To provide a rigorous test more indicative of performance in a consumer environment, the white board used in the testing was of a type which had been subjected to typical use for approximately one year. The board thus provided a used, presumably relatively porous writing surface compared to a new board. The markers according to the disclosure herein were assessed side-by-side with commercial products marketed by Binney & Smith, Inc. as CRAYOLA Washable Dry Erase Markers, thin line (eight count, product code #26-8401), marked with U.S. Pat. Nos. 5,968,241 and 5,900,094. Attempts were made to erase the marks with a typical felt white board eraser and the cleanliness of the board after erasure was assessed visually. The results are tabulated in Table 7 below.

TABLE 7

Cleanliness*

| Ink Color | Inks of Examples 1-6 | Commercial Product |
|---|---|---|
| Yellow | 0 | 1 |
| Blue | 1 | 4 |
| Magenta | 0 | 4 |
| Green | 0 | 3 |
| Purple | 0 | 4 |
| Red | 0 | 1 |

*Cleanliness was assessed by comparing the amount of residue left on the board after erasure by a felt eraser. The overall cleanliness was graded on a 0 to 4 scale where “0” indicated that no residue was left on the board after erasure, and “4” indicated that marks were not erased at all. The white board used was made by Boone.

As indicated in Table 7, the formulations according to the disclosure provide significant improvement over existing commercial products in erasability performance.

### Example 8

### Washability

To assess washability marks were made with the inks described in Examples 1-6 on a multi-fabric test strip from TestFabrics; Inc. of Pittston, Pa. The test strips included eight fabrics made from acetate, cotton, nylon, polyester, polyacrylic, silk, viscose, and wool fibers, respectively. The marked test strips were divided into two portions, each containing marks. One half was retained as standards and the other half was put into a laundry machine and washed with a full load of clothes to simulate performance in a consumer environment. Washability of the inks was assessed visually by comparing the intensity of the ink marks before and after washing. Following washing, no fabric retained any color mark (i.e., no staining).

The foregoing description is given for clearness of understanding only, and no unnecessary limitations should be understood therefrom, as modifications within the scope of the invention may be apparent to those having ordinary skill in the art.

What is claimed is:

1. An ink useful for dry erase applications, comprising a mixture of a pigment having a particle size of at least about 1 μm, a binder, a release agent, and water.

2. The ink of claim 1, wherein said pigment has a particle size of at least about 2 μm.

3. The ink of claim 2, wherein said pigment has a particle size of at least about 5 μm.

4. The ink of claim 1, wherein said pigment has a particle size of about 40 μm or less.

5. The ink of claim 1, wherein said pigment comprises a metallic pigment.

6. The ink of claim 1, wherein said pigment comprises an organic pigment.

7. The ink of claim 1, comprising said pigment in an amount of at least about 0.1 wt. % and about 80 wt. % or less.

8. The ink of claim 7, comprising said pigment in an amount of at least about 1 wt. % and about 10 wt. % or less.

9. The ink of claim 1, wherein said binder is water soluble.

10. The ink of claim 1, comprising said binder in an amount of at least about 0.5 wt. %.

11. The ink of claim 1, wherein said release agent comprises a silicone.

12. The ink of claim 11, wherein said release agent comprises a polyalkylene oxide-modified polydimethylsiloxane

13. The ink of claim 1, comprising said release agent in an amount of at least about 0.5 wt. % and about 30 wt. % or less.

14. The ink of claim 1, further comprising a co-solvent.

15. The ink of claim 14, wherein said co-solvent comprises an alcohol.

16. The ink of claim 14, comprising said co-solvent in an amount of at least about 10 wt. %.

17. The ink of claim 1, further comprising a dye.

18. The ink of claim 17, wherein said dye comprises a polymeric dye.

19. The ink of claim 17, comprising said dye in an amount of at least about 0.5 wt. %.

20. The ink of claim 1, further comprising a surfactant.

21. The ink of claim 20, wherein said surfactant is a phosphate ester surfactant.

22. An ink useful for dry erase applications, comprising a mixture of a pigment having a particle size of at least about 1 μm, a water-soluble binder, a silicone release agent, water, and an alcohol co-solvent.
